(19) United States
(12) Patent Application Publication
(10) Pub. No.: US 2023/0394586 A1
(43) Pub. Date: Dec. 7, 2023

(54) SYSTEM AND METHOD FOR AGGREGATING REAL-TIME MORTGAGE INSURANCE RATE QUOTES FOR MORTGAGE BROKERS

(71) Applicants: Selena Chen Monsell, Denver, CO (US); Alexander Robert Monsell, Denver, CO (US); Anthony DiTomasso, Manchester, NH (US)

(72) Inventors: Selena Chen Monsell, Denver, CO (US); Alexander Robert Monsell, Denver, CO (US); Anthony DiTomasso, Manchester, NH (US)

(21) Appl. No.: 18/206,903

(22) Filed: Jun. 7, 2023

Related U.S. Application Data
(60) Provisional application No. 63/365,990, filed on Jun. 7, 2022.

(51) Int. Cl. G06Q 40/08; G06Q 40/03

(52) U.S. Cl. CPC G06Q 40/08; G06Q 40/03

(57) ABSTRACT

A novel computer-based mortgage insurance rate quote platform, system, and methods for aggregating real-time mortgage insurance rate quotes, presenting more accurate quotes to brokers in real-time, eliminating the lenders' role in obtaining the quotes, and enabling brokers to use the computer-based mortgage insurance rate quote platform to more quickly and accurately prepare a loan packet.

### CROSS-REFERENCE TO RELATED APPLICATION

The present application claims priority to U.S. Provisional Patent Application Ser. No. 63/365,990, filed Jun. 7, 2022, entitled “SYSTEM AND METHOD FOR AGGREGATING REAL-TIME MORTGAGE INSURANCE RATE QUOTES FOR MORTGAGE BROKERS”, which is hereby incorporated by reference in its entirety.

### BACKGROUND

### a. Technical Field of the Disclosure

The present disclosure relates generally to a system and methods for aggregating accurate, real-time mortgage insurance rate quotes. More particularly, the present disclosure relates to a system and methods for aggregating accurate, real-time mortgage insurance rate quotes and presenting accurate rate quotes in real-time to mortgage brokers thereby eliminating the lenders' role in obtaining mortgage insurance rate quotes, and enabling the mortgage broker to use a computer-based mortgage insurance rate quote platform to more quickly and accurately prepare a loan packet for a real estate sale.

### b. Background of the Disclosure

When purchasing real estate, there are a number of items that the purchaser must obtain to complete the purchase. These items include a purchase contract, an appraisal, a mortgage, usually from a bank, investor or lender (all of the foregoing referred to herein as lenders), and mortgage insurance, among other items.

Specifically, the mortgage insurance is a vehicle to protect from losses due to non-payment of the mortgage. In other words, mortgage insurance is an insurance policy that compensates lenders in mortgage-backed securities for losses due to the default of a mortgage loan. Mortgage insurance can be either public or private depending upon the insurer.

Private mortgage insurance (PMI) is typically required with most conventional or non-government backed mortgage programs when the down payment or equity position is less than twenty percent of the property value. In other words, when purchasing or refinancing a home with a conventional mortgage, if the loan-to-value (LTV) is greater than eighty percent, the borrower will likely be required to carry private mortgage insurance.

Borrower paid private mortgage insurance (BPMI), is the most common type of PMI in the mortgage lending marketplace. BPMI allows borrowers to obtain a mortgage without having to provide twenty percent down payment, by covering the lender for the added risk of a high LTV mortgage. Borrowers can request PMI cancellation when the amount owed is reduced to the eighty percent LTV level. Additionally, cancellation of borrower-paid mortgage insurance occurs when the loan is scheduled to reach seventy-eight percent of the original appraised value or sales price, whichever is less. The schedule is based on the original amortization schedule for fixed-rate loans and the current amortization schedule for adjustable-rate mortgages. BPMI can, under certain circumstances, be cancelled earlier by the servicer ordering a new appraisal showing that the loan balance is less than eighty percent of the home's value due to appreciation.

Likewise, lender paid private mortgage insurance (LPMI) is similar to BPMI except that it is paid by the lender and built into the interest rate of the mortgage. LPMI is usually a feature of loans that do not require mortgage insurance for high LTV loans. The advantage of LPMI is that the total monthly mortgage payment is often lower than a comparable loan with BPMI. However, because it is built into the interest rate, a borrower cannot cancel the insurance when the equity position reaches the required LTV level without refinancing.

A mortgage broker acts as an intermediary who brokers mortgage loans on behalf of individuals or businesses. As markets for mortgages have become more competitive, mortgage brokers are used to sell a lending institute's products. Additionally, a real estate broker, real estate agent or realtor is a person who represents sellers or buyers of real estate or real property. While brokers may work independently, an agent usually works under a licensed broker to represent clients. Brokers and agents are licensed by the state to negotiate sales agreements and manage the documentation required for closing real estate transactions. Buyers and sellers are generally advised to consult a licensed real estate professional for a written definition of an individual state's laws of agency, and many states require written disclosures to be signed by all parties outlining the duties and obligations.

Along those lines, mortgage brokers, real estate brokers, real estate agents or realtors (all of the foregoing referred to herein as brokers) work with their clients to obtain the necessary documents and products for the real estate purchase. Usually, brokers are not paid unless the real estate deal closes.

Brokers have a fiduciary duty to build a complete loan packet for the client, which includes mortgage insurance among other items. Brokers must first get mortgage insurance quotes or estimates before a buyer can decide which mortgage insurance to purchase. However, brokers currently have only one option to obtain mortgage insurance quotes for their clients. They first have to reach out to each individual lender to provide the loan data for the quote(s). The lender then reaches out to the different mortgage insurance providers (i.e., Essent, Enact MI, National MI, Radian, and MGIC, among others), and manually enters in all of the loan data. This must be done each time to obtain a single rate quote from each of the providers. Additionally, if the brokers are comparing different products, they will have to repeat the process several times over, and then compare the results manually.

Existing patent applications and products pertain to lenders and others to search for mortgage insurance rate estimates to provide to the brokers, when the brokers provide the loan data and request quotes. None of these references, however, disclose the functionality of aggregating accurate, real-time mortgage insurance rate quotes, and presenting these accurate rate quotes in real-time to mortgage brokers, thereby eliminating the lenders' role in obtaining mortgage insurance rate quotes.

For example, Australian Patent Application No. AU2015200557A1, titled Mortgage Insurance Premium Calculation Method, System & Apparatus, to Christopher Ronald Edward Joye, et al., discloses a method, apparatus and system for computing mortgage insurance premiums for shared equity mortgages. Shared equity mortgages rank behind a conventional interest bearing first mortgage and both mortgages are secured over the same property. Details of the mortgages and property are stored in the data store of a computer system. The future sale price at predetermined future dates for each property is estimated in order to calculate each possible future loss in the event that the shared equity mortgage is terminated at each future date. This information and an estimated probability of termination at each future dates are used to calculate an appropriate insurance premium.

Another example, US Patent Application No. US20130185101A1, titled System, Method, and Computer Program Product for Underwriting Mortgage Loan Insurance, to Kim Garland, et al., discloses underwriting systems and methods that include a non-transitory, tangible computer-readable storage medium bearing instructions for performing underwriting steps for a mortgage insurance product for a mortgage between a borrower and a lender. A processor is adapted to execute an underwriting program contained on the computer-readable medium. A web-enabled interface is adapted to exchange information with partner sites, including to receive loan information, to send mortgage insurance information generated by the underwriting program, and to receive borrower credit information. The underwriting program includes a post-closing underwriting module adapted to perform a post-closing fraud analysis using the loan information received through the web-enabled interface and adapted for use in performing at least a portion of a post-closing borrower credit review using the borrower credit information received through the web-enabled interface within a predetermined period of time after the loan has closed and before a claim under the mortgage insurance product has been received.

Yet another example, US Patent Application No. US20050108028A1, titled Methods and Apparatus for Marketing Mortgage Insurance and Associated Products and Performing Transactions including Mortgage Insurance, to Kurt Arehart, discloses systems and techniques for marketing and implementing transactions involving mortgage financing. A system according to one aspect of the invention includes a data repository storing information used to design financial products and a product database including information relating to various products. At least one of the products for which information is stored in the database includes adjusting the amount of the loan to include an excess amount, adjusting the interest rate of the loan to a rate above the prevailing rate and optionally including a prepaid mortgage insurance policy with the loan, and allowing the borrower the option of purchasing discount points to reduce the interest rate to the prevailing rate. The technique further includes disbursing the excess amount of the loan to the borrower. The system may also include a comparison module receiving transaction information, computing the financial effects of available products and presenting the results to the borrower.

However, there are no known products or patent references that allow for aggregating accurate, real-time mortgage insurance rate quotes and presenting accurate insurance rate quotes to a broker, thereby eliminating the lenders' role in obtaining mortgage insurance rate quotes. Additionally, there are no known patent references or products that enable a broker to use a computer-based mortgage insurance rate quote platform to more quickly and accurately prepare a loan packet, by including real-time mortgage insurance rate quotes that are immediate and accurate. Accordingly, there is a need for such a platform to generate more robust and precise mortgage insurance rate quotes for enabling brokers to prepare loan packets for their clients.

### BRIEF SUMMARY

A general objective of the present disclosure is a computer-based mortgage insurance rate quote platform that overcomes the deficiencies of existing platforms and systems by providing aggregation of real-time mortgage insurance rate quotes and presenting accurate insurance rate quotes to a broker, thereby eliminating the lenders' role in obtaining mortgage insurance rate quotes.

Another general objective of the present disclosure is a computer-based mortgage insurance rate quote platform that provides for the broker to obtain accurate quotes quicker and for the client to thereby make more informed and quicker mortgage insurance rate decisions.

An objective of the present disclosure, a computer based mortgage insurance rate quote platform overcoming the deficiencies of existing platforms and systems by providing aggregation of real-time mortgage insurance rate quotes and presenting accurate insurance rate quotes to a broker, thereby eliminating the lenders role in obtaining mortgage insurance rate quotes, is to aggregate multiple mortgage insurance rate quotes related to a single real estate transaction and presents those quotes to the broker in an easily understandable format.

Another objective of the present disclosure is a computer-based mortgage insurance rate quote platform that overcomes the deficiencies of existing platforms and systems by generating more timely, robust and accurate mortgage insurance rate quotes for enabling brokers to prepare loan packets for their clients.

Yet another objective of the present disclosure is a computer-based mortgage insurance rate quote platform that overcomes the deficiencies of existing platforms and systems by providing improved aggregation of relevant mortgage insurance rate information.

Yet another objective of the present disclosure is a computer based mortgage insurance rate quote platform that overcomes the deficiencies of existing platforms and systems by providing improved aggregation and calculations of accurate mortgage insurance rate quotes for all of the lenders that the mortgage brokerages partner with by using a lender's master policy number to access one or more of the mortgage insurance provider's rate quotes in real-time securely, rather than providing an estimated quote, without exposing confidential identifiers. The master policy number is an identification number or ID number for the business inside each of the insurance providers' systems. This master policy number is unique to each lender and every provider has a different number for the same lender. This specific master policy number allows lenders to negotiate rates and to apply those discounts every time a quote is pulled.

Other objects and advantages of the present disclosure will become apparent to one having ordinary skill in the art after reading the specification in light of the drawing figures, however, the spirit and scope of the present disclosure should not be limited to the description of the embodiments contained herein.

### BRIEF DESCRIPTION OF THE DRAWINGS

FIG. 1 is a block diagram illustrating an exemplary embodiment of a mortgage insurance rate quote communication network in accordance with the present disclosure.

FIG. 2 is a flow chart illustrating an exemplary embodiment of a mortgage insurance rate quote platform in accordance with the present disclosure.

FIG. 3 is a flow chart illustrating an exemplary embodiment of a mortgage insurance rate quote platform in accordance with the present disclosure.

FIG. 4 depicts an exemplary set of input variables pertaining to mortgage insurance rate quotes in a graphical user interface (GUI) that may be provided consistent with the present disclosure.

FIG. 5 depicts an exemplary set of mortgage insurance rate quotes in a GUI that may be provided consistent with the present disclosure.

### DETAILED DESCRIPTION

Referring to the drawings, wherein like reference numerals refer to the same or similar features in the various views, the present disclosure relates generally to a computer-based mortgage insurance rate quote platform, system and methods for aggregating real-time mortgage insurance rate quotes, presenting more accurate quotes to brokers, eliminating the lenders role in obtaining the quotes, and enabling brokers to use the computer-based mortgage insurance rate quote platform to more quickly and accurately prepare a loan packet.

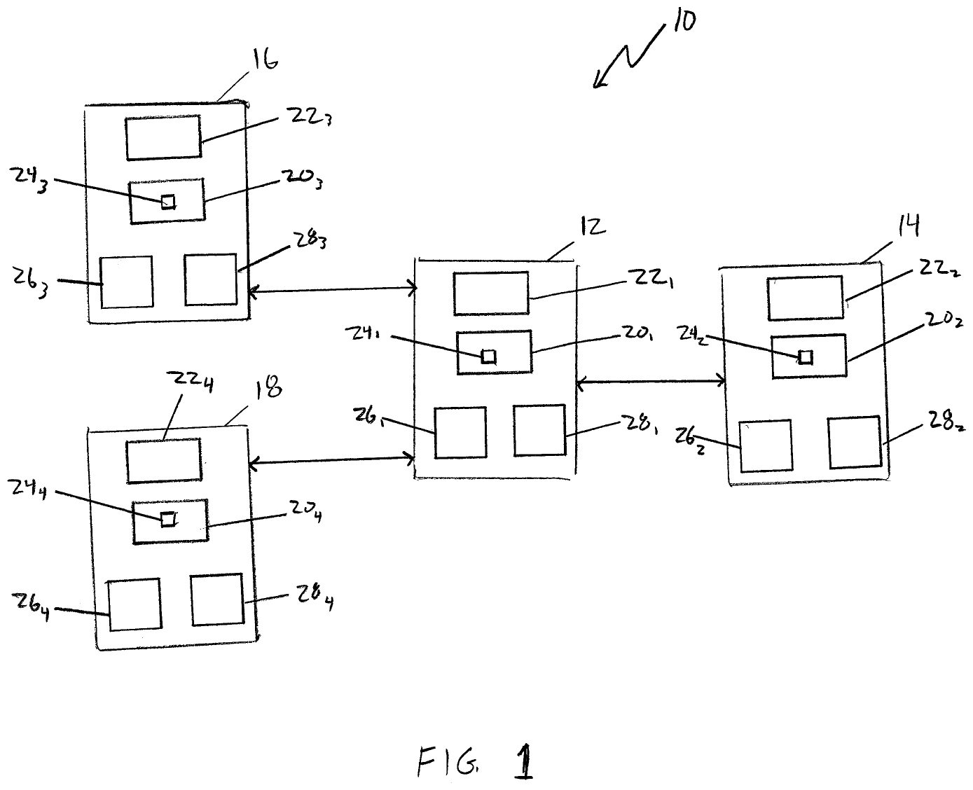

FIG. 1 is a block diagram view of an exemplary mortgage insurance rate quote or estimate system 10 for providing mortgage insurance rate quotes to mortgage brokers, bypassing the lender's role. The mortgage insurance rate quote system 10 may include a mortgage insurance rate quote platform 12, a mortgage broker system 14, a mortgage insurance provider system 16, and a lender system 18. The mortgage insurance rate quote platform 12, a mortgage broker system 14, a mortgage insurance provider system 16, and a lender system 18 may each include a respective computer-readable memory 20₁, 20₂, 20₃, 20₄ (which may be referred to generically herein as memory 20) configured to store instructions and a respective processor 22₁, 22₂, 22₃, 22₄ (which may be referred to generically herein as processor 22) configured to execute the instructions stored in the associated memory 20₁, 20₂, 20₃, 20₄.

A first copy or version of a mortgage insurance rate quote application 24₁ (which may be referred to generically herein as application 24) may be stored in the memory 20₁ associated with the mortgage insurance rate quote platform 12. Additional copies or versions of the mortgage insurance rate quote application 24₂, 24₃, 24₄ may be stored in one or more of the memories 20₂, 20₃ and/or 20₄ associated with the mortgage broker system 14, the mortgage insurance provider system 16, and/or the lender system 18. Each of these systems may additionally include a display 26₁, 26₂, 26₃, 26₄ and/or a web browser 28₁, 28₂, 28₃, 28₄, as necessary (which may be referred to generically as display 26 or web browser 28, respectively).

Information that is “stored” in a computer-readable memory may be in any form. For example, the application 24 may be stored in a memory 20 in executable form, in the form of an installation file, in a non-executable form comprising the files and directories necessary to build an executable version of the application 24, or in some other form.

Each of the processors 22 and memories 20 may be of a suitable type and in a suitable configuration for the functionality described herein. Additionally or alternatively, any of the mortgage insurance rate quote platform 12, mortgage broker system 14, mortgage insurance provider system 16, and lender system 18 may include a programmable logic device (PLD), application-specific integrated circuit (ASIC), or other processing device. Each memory 20 may be or may include any non-volatile computer-readable memory, in an embodiment. Each associated processor 22 and memory 20 may be in communication with another processor 22 and memory 20 via any communication bus and/or other wired or wireless electronic communication means (shown as arrows in FIG. 1). In addition, the displays 26 of the mortgage insurance rate quote platform 12, mortgage broker system 14, mortgage insurance provider system 16, and lender system 18 may be in communication with the processor 22 and/or memory 20 of the respective systems over any communication bus and/or other wired or wireless electronic communication means.

The mortgage insurance rate quote platform 12, mortgage broker system 14, mortgage insurance provider system 16, and lender system 18 may be or may include a personal computer or mobile device (e.g., tablet, smart phone), in an embodiment. However, these systems are not limited to such embodiments. Rather, the systems may be any computing system appropriate for performing the functionality described herein.

In an embodiment, the mortgage insurance rate quote platform 12, mortgage broker system 14, mortgage insurance provider system 16, and lender system 18 may include the web browser 28 (e.g., a web browser 28 may be installed in the memory 20 of one or more systems). The mortgage insurance rate quote platform 12, mortgage broker system 14, mortgage insurance provider system 16, and lender system 18 may be in electronic communication with a web server (not shown) for example over the Internet. A web server may provide one or more webpages that may be accessed by the mortgage broker system 14 (e.g., via the web browser 28) and viewed on the display 26. The mortgage insurance rate quote platform 12, mortgage insurance provider system 16, and lender system 18 may also have access to the web server through their respective web browsers 28, or in other ways as understood by one having ordinary skill in the art.

The webpages may include pages associated with the mortgage insurance rate quote system 10. The webpages provided by the web server may include information or requests for information pertaining to one or more loans, as described herein. For example, a loan information webpage provided by the web server, based on the mortgage insurance rate quote application 24, may include information about a particular loan for which a mortgage insurance rate quote is needed by a mortgage broker 30 from a mortgage insurance provider 32 for a particular lender 34 so the mortgage broker 30 can complete the loan package for a deal.

As set forth herein, the mortgage insurance rate quote system 10 is configured to use the mortgage insurance rate quote application 24 to provide a mortgage insurance rate quote from at least one mortgage insurance provider 32 (for example through the mortgage insurance provider's api 24₃) to a mortgage broker 30 so that the mortgage broker 30 can use that information to complete a loan package.

For example, the mortgage insurance rate quote platform 12 may provide a downloadable installation file including the mortgage insurance rate quote application 24 or a version thereof for the mortgage broker system 14 to utilize. Once the mortgage broker 30 populates the webpage with the loan information, the mortgage insurance rate quote application 24 resident on or associated with the mortgage insurance rate quote platform 12, can use that information to obtain the accurate, real-time mortgage insurance rate quotes to ultimately be transmitted to the mortgage broker system 14.

Additionally or alternatively, the mortgage insurance rate quote platform 12 may store the mortgage insurance rate quote application 24. For example, the mortgage insurance rate quote platform 12 may provide the mortgage insurance rate quote application 24 on a software-as-a-service basis, and the application 24 may be accessed via a client on the mortgage broker system 14, such as a client associated with the web browser 28.

The memory or memories 20 may be or may include one or more data repositories including, but not limited to, one or more databases and database types as well as data storage that may not necessarily be colloquially referred to as a “database.” The memory 20 may store one or more records pertaining to a particular loan event. For example, the memory 20 may store records of the real estate loan particulars, such as loan numbers, amounts, address information, credit scores, and social security numbers. Additionally or alternatively, the memory 20 may store records of the loan type and purpose, interest rates, among other loan particulars. The memory 20 may be populated and/or updated by an operator or user of the mortgage broker system 14, or in other ways as set forth in the system 10. As used in this disclosure, a “user” may refer to an individual or a larger entity. For example, a user may be an individual mortgage broker 30 or a mortgage brokerage firm associated with the mortgage broker 30.

As described below, the memory 20, especially the memory in the mortgage insurance rate quote platform 12, may be populated by populating a webpage provided by the mortgage insurance rate quote application 14, in an embodiment. For example, a user is provided a webpage 28 requesting data pertaining to the particular loan and the user populates that webpage and the system 10 then transmits that data to the platform 12 for further processing, as described herein. In an embodiment, the webpage display and data entry may be performed by the mortgage insurance rate quote application 24 when the user is logged in to the system 10 through a browser 28 in which the application 24 is running.

As detailed herein, the information that is identified and collected by the mortgage insurance rate quote application 24 from a webpage 28 in an example may include, but is not limited to, loan number, loan amount, whether a second mortgage is present, loan to value determination, address, housing expense ratio, debt-to-income, non-traditional credit, number of borrowers, credit score, total monthly income, social security number, self-employment, bankruptcy and foreclosure status, occupancy type, loan type, estimated mortgage interest rate, loan purpose, amortization, property type, number of units, renewal option, refundable premium and lender, and the like. The mortgage insurance rate quote application 24 may compare the populated or collected information with previous information stored in the memory 20 to determine if the information is accurate and should be passed on to the lender 34, or if the information should be flagged as necessary, an error displayed to the user and the transaction stopped.

In an embodiment, the mortgage insurance rate quote application 24 may be associated with the web browser 28 on the mortgage broker system 14. For example, the mortgage insurance rate quote application 24 may be an extension, plug-in, or add-on to the browser 28. The mortgage insurance rate quote application 24 may be configured to extract information from the browser interface and to superimpose that information on the browser interface for showing on the display 26 of the mortgage broker system 14.

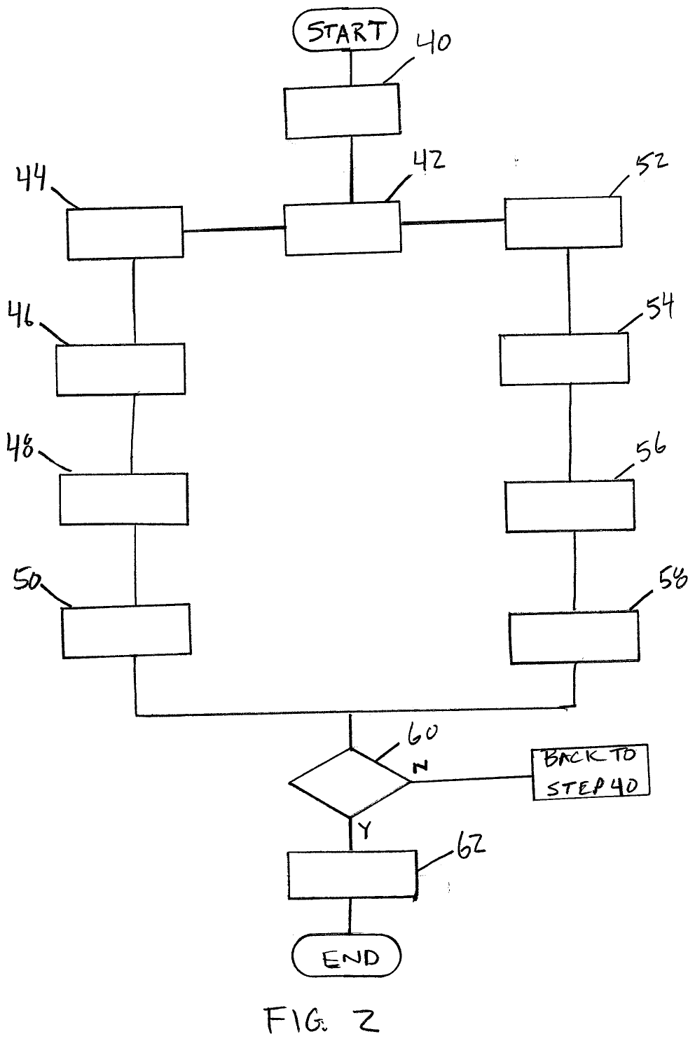

As generally described herein, the mortgage insurance rate quote application 24 may interact with the memory 20 and the web browser 28 to display loan records or information stored in the memory 20 with a webpage provided by the web browser 28. FIGS. 2 through 5 generally illustrate through flow charts and webpages 28 an exemplary operation of the mortgage insurance rate quote application 24 in a web browser interface.

As such, the computer-based mortgage insurance rate quote system 10, including the mortgage insurance rate quote platform 12, along with the mortgage insurance rate quote application 24 provides a system and methods for aggregating more accurate, real-time mortgage insurance rate quotes based on information a user provides to the system, presenting the more accurate real-time quotes to mortgage brokers, thereby eliminating the lenders' role in obtaining the quotes, and enabling the mortgage brokers to use the computer-based mortgage insurance rate quote platform to more quickly and accurately prepare a loan packet with accurate, real-time mortgage insurance rate quotes.

FIG. 2 is a flow chart showing an embodiment of a method of aggregating more accurate, real-time mortgage insurance rate quotes in accordance with an example of the present disclosure. The method of aggregating the rate quotes begins with a step 40 that includes the mortgage broker 30 entering details pertaining to the loan event into the mortgage insurance rate quote system 10, for example, by populating a webpage with lender information as described herein.

The webpage is populated with information pertaining to the particular loan event as described herein. In this example, the mortgage insurance rate quote application 24 provides the webpage to the mortgage broker 30 through the mortgage broker system 14.

The entered or populated information is then transmitted to the mortgage insurance rate quote platform 12 and stored at step 42. Once transmitted, the mortgage insurance rate quote application 24 will then request verifications from the mortgage insurance provider 16 and the lender system 18 to continue the procedure.

At step 44, the mortgage insurance rate quote application 24 request verification from the lender 34 through lender system 18. The lender system 18 receives the request from the mortgage insurance rate quote platform 12 through the mortgage insurance rate quote application 24, at step 46. Then at step 48, the lender 34 through lender system 18, confirms the relationship with the mortgage broker 30.

To confirm the relationship at step 48, the lender 34 is presented with a unique identifier that corresponds to the requesting broker 30. This unique identifier can only be authenticated by the mortgage insurance rate quote platform 12, part of the mortgage insurance rate quote system 10, which may comprise a look up table that maps or associates lender possessed broker identification to broker possessed lender identification. This provides a multi-layer verification process that minimizes the opportunity for fraudulent requests to bypass security. If the relationship is not properly verified through the system 10, a manual verification request is automatically transmitted to the lender 34 to account for the possibility of user error. To prevent the ability of the end user to make multiple malicious attempts to access the system, IP addresses are logged and limited to a single request per lending entity 34. The user is given a pending message regardless of pending result or failure, until manual verification has been performed.

Once the lender 34 confirms the relationship with the mortgage broker 30, the response is sent to the mortgage insurance rate quote platform 12 at step 50.

Concurrent or nearly concurrent with steps 44 through 50, the mortgage insurance rate quote application 24 will request verification from the mortgage insurance provider system 16 at step 52. The mortgage insurance provider system 16 receives the request from the mortgage insurance rate quote platform 12 through the mortgage insurance rate quote application 24 at step 54.

Next, the mortgage insurance provider system 16 retrieves the master policy number for the lender 34 at step 56. The master policy numbers are provided prior to request by the lender 34. Upon receipt of a valid broker's unique identifier, and verification from the lender 34, these master policy numbers are provided by the system 10 to the mortgage insurance provider 32. This number is static per the lender 34 and mortgage insurance provider 32 relationship. If this number were to change, the lender 34 would be required to provide the system 10 with their updated master policy number.

At step 58, the mortgage insurance provider system 16 sends the master policy number to the mortgage insurance rate quote platform 12 through the mortgage insurance rate quote application 24.

At step 60, the system 10 has checked for both the lender 34 to have confirmed the relationship with the mortgage broker 30 (step 48), and the mortgage insurance provider system 16 has sent the master policy number to the mortgage insurance rate quote platform 12 (step 58), both through the mortgage insurance rate quote application 24.

If both have occurred successfully, the system 10 provides the mortgage broker 30 with access to the lender specific mortgage insurance rate quotes at step 62. As detailed herein, the specific mortgage insurance rate quotes are accurate and provided in real-time. To the extent that there is no confirmation of a relationship with the mortgage broker 30, the specific mortgage insurance rate quotes are not provided to the mortgage broker 30. In this case, the system will start over with step 40 or, assuming the loan parameters meet the mortgage insurance provider's 32 underwriting guidelines, the specific mortgage insurance rate quotes will use default rates provided by the mortgage insurance company.

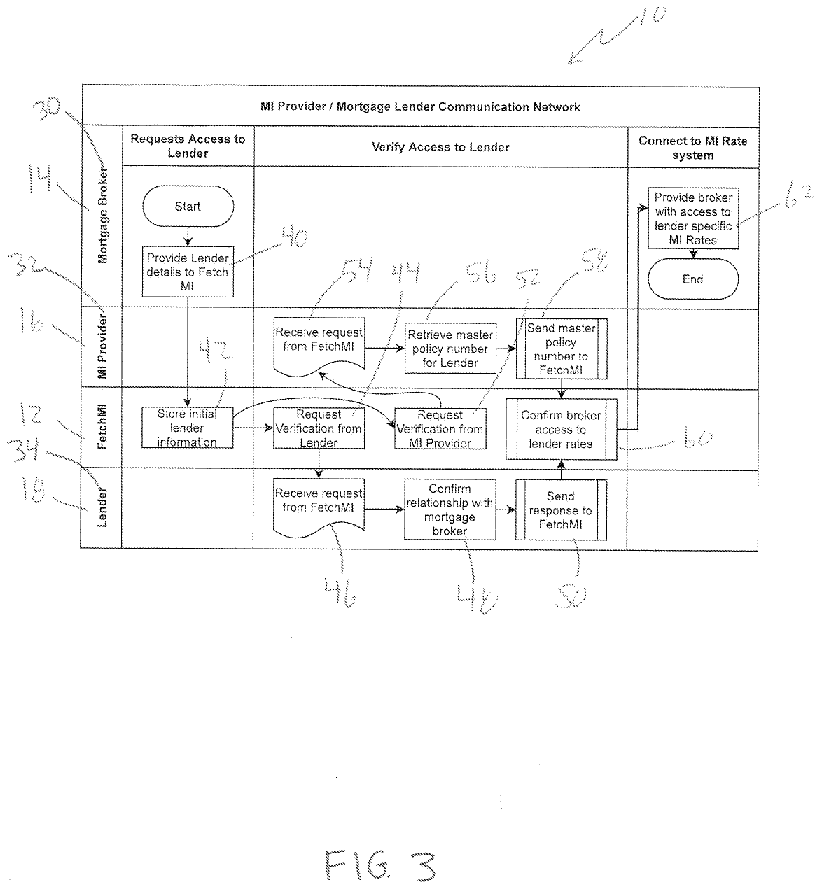

FIG. 3 is functional flow chart describing an embodiment of a method of aggregating more accurate, real-time mortgage insurance rate quotes in accordance with an example of the present disclosure. FIG. 3 displays the functional flow of the method based on the party taking the action in the left column (mortgage broker 30, mortgage insurance provider 32, mortgage insurance rate quote platform 12, and lender 34). Additionally, the general action being taken and to whom is set out in the top row (requesting access to the lender, verifying access to the lender, connecting to the mortgage insurance rate quote system).

As set forth above, in steps 40 and 42, the mortgage broker 30 provides loan information to the mortgage insurance rate quote platform 12, which is then stored.

Steps 44 through 50 occur between the lender 34 through the lender system 18, and the mortgage insurance rate quote platform 12 through the mortgage insurance rate quote application 24. As detailed above, these steps are intended to confirm (or deny) the relationship between the lender 18 and the mortgage broker 30, using the mortgage insurance rate quote platform 12. Again, the onboarding process for a mortgage broker 30 includes the transmission of a unique identifier previously established as a trusted identifier for the broker 30 with the lender 34. The transmission of the identifier with positive response from the lender would result in the automatic association of the broker 30 and lender 34 in the system via the lender's master policy numbers for negotiated mortgage insurance rates.

Steps 52 through 58 occur between the one or more mortgage insurance providers 32 through the mortgage insurance provider system 16, and the mortgage insurance rate quote platform 12 through the mortgage insurance rate quote application 24. As detailed above, these steps are intended to provide the master policy number to the mortgage insurance rate quote platform 12.

In step 60, the system 10 checks for the lender 34 to confirm the relationship with the mortgage broker 30, and the mortgage insurance provider system 16 sent the master policy number to the mortgage insurance rate quote platform 12. If both of these events have completed successfully, the mortgage broker 30 can be provided access to the lenders' 34 accurate, real-time mortgage insurance rate quotes and the mortgage broker 30 can prepare the loan package, effectively removing the lender 34 from the process, and the delay associated therewith.

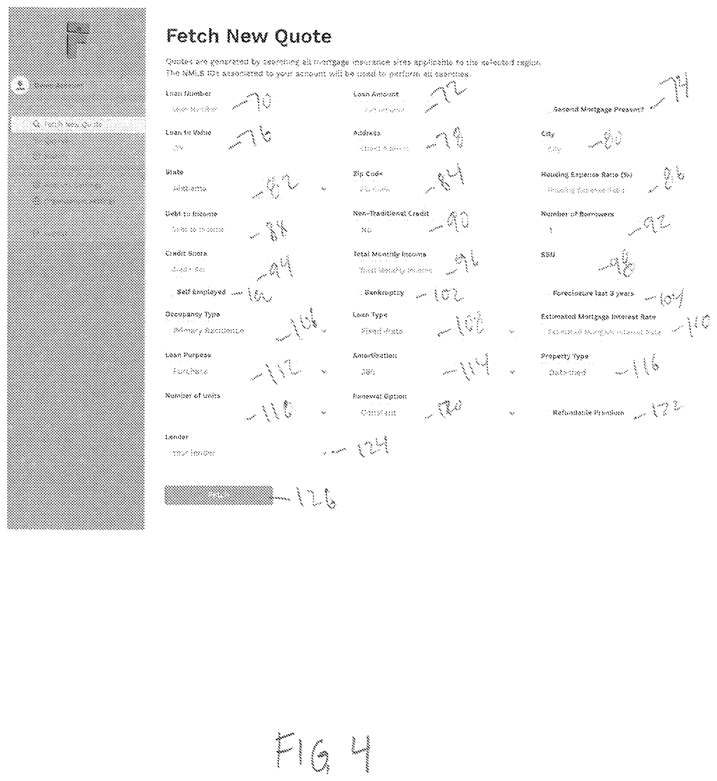

FIG. 4 is an exemplary screen shot for a set of input variables pertaining to mortgage insurance rate quotes in a GUI. Along those lines, FIG. 4 shows an embodiment of the method of aggregating more accurate, real-time mortgage insurance rate quotes by first populating a webpage with lender information.

Initially, as an example, the mortgage broker 30 will be provided the webpage in FIG. 4 from the mortgage insurance rate quote application at the mortgage broker system 14. The mortgage broker 30 then populates the webpage 28 with the loan information for the particular real estate loan, which may include, but is not limited to, the loan number 70, the loan amount 72, whether there is a second mortgage 74, the loan to value determination 76, the street address 78, the city 80, the state 82, the zip code 84, and the housing expense ratio 86. Additional information may include, the debt-to-income 88, the non-traditional credit 90, the number of borrowers 92, the credit score 94, the total monthly income 96, the social security number 98, self-employed 100, bankruptcy 102 and foreclosure 104 status, the occupancy type 106, the loan type 108, the estimated mortgage interest rate 110, the loan purpose 112, the amortization 114, the property type 116, the number of units 118, the renewal option 120, the refundable premium 122 and the lender 124, and the like.

Once some or all of these entries have been populated with the loan information, the mortgage broker 30 can select the FETCH radial button 126, and the system 10 will transfer the initial lender information to the mortgage insurance rate quote platform 12 (step 42), to begin the process described in FIGS. 2 and 3.

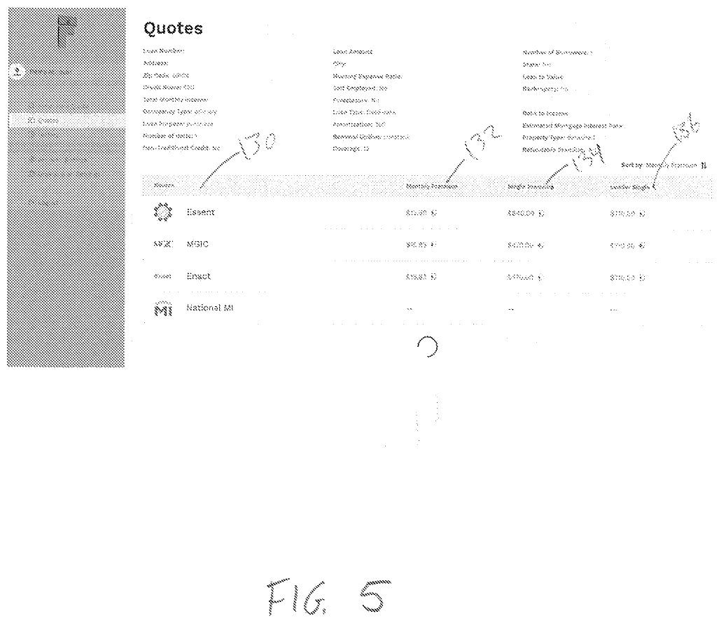

FIG. 5 is an exemplary screen shot for a set of mortgage insurance rate quotes in a GUI format. Along those lines, FIG. 5 shows an embodiment of the method of aggregating more accurate, real-time mortgage insurance rate quotes and the webpage with the resulting mortgage insurance rate quotes determined and displayed by the mortgage insurance rate quote platform 12.

FIG. 5 shows an exemplary webpage with the resulting mortgage insurance rate quotes in a GUI format. In particular, FIG. 5 shows the source 130 of the one or more mortgage insurance rate quotes, the monthly premium 132, the single premium 134, and the lender single amount 136. Of course, additional information pertaining to the mortgage insurance rate quotes can be included (or certain information removed) from the resulting webpage.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings.

It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment.

Further, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although numerous embodiments of this invention have been described above with a certain degree of particularity, those skilled in the art could make numerous alterations to the disclosed embodiments without departing from the spirit or scope of this disclosure.

All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure.

As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, which is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A mortgage insurance rate quote system for aggregating and presenting accurate, real-time real estate mortgage insurance rate quotes, comprising:
a mortgage insurance rate quote platform, said mortgage insurance rate quote platform aggregating and presenting accurate, real-time real estate mortgage insurance rate quotes;
a mortgage broker system, said mortgage broker system controlled by a mortgage broker, said mortgage broker capable of preparing a loan packet based on accurate, real-time real estate mortgage insurance rate quotes from said mortgage insurance rate quote platform;
a mortgage insurance provider system, said mortgage insurance provider system capable of providing an accurate, real-time master policy quote to said mortgage insurance rate quote platform;
a lender system, said lender system comprising at least one lender, said lender system capable of providing a verification of a relationship between said at least one lender and said mortgage broker.

2. The mortgage insurance rate quote system for aggregating and presenting accurate, real-time real estate mortgage insurance rate quotes in claim 1, wherein said mortgage insurance rate quote platform performs the steps of:
a) receive a loan information from a mortgage broker,
b) request a verification from said lender system as to a relationship between said at least one lender and said mortgage broker
c) obtain said verification from said lender system,
d) obtain an accurate, real-time master policy mortgage insurance rate quote from said mortgage insurance provider system; and
e) upon verification, transmit said accurate, real-time master policy mortgage insurance rate quote to said mortgage broker system for mortgage broker to prepare said loan packet.

3. The mortgage insurance rate quote system for aggregating and presenting accurate, real-time real estate mortgage insurance rate quotes in claim 2, wherein said loan information comprises a lender, a loan number, a loan amount, an indicator as to whether a second mortgage is present, a loan to value determination.

4. The mortgage insurance rate quote system for aggregating and presenting accurate, real-time real estate mortgage insurance rate quotes in claim 2, wherein said loan information comprises a street address, a city, a state, as zip code, a housing expense ratio.

5. The mortgage insurance rate quote system for aggregating and presenting accurate, real-time real estate mortgage insurance rate quotes in claim 2, wherein said loan information comprises a debt-to-income calculation, an indicator of non-traditional credit, a number of borrowers, a credit score, a total monthly income.

6. The mortgage insurance rate quote system for aggregating and presenting accurate, real-time real estate mortgage insurance rate quotes in claim 2, wherein said loan information comprises a social security number, an indication of self-employment, a bankruptcy and foreclosure status, an occupancy type.

7. The mortgage insurance rate quote system for aggregating and presenting accurate, real-time real estate mortgage insurance rate quotes in claim 2, wherein said loan information comprises a loan type, an estimated mortgage interest rate, a loan purpose, an amortization schedule, a property type, a number of units, a renewal option, a refundable premium.

8. The mortgage insurance rate quote system for aggregating and presenting accurate, real-time real estate mortgage insurance rate quotes in claim 2, wherein said accurate, real-time master policy quote comprises a mortgage insurance rate quote.

9. The mortgage insurance rate quote system for aggregating and presenting accurate, real-time real estate mortgage insurance rate quotes in claim 2, wherein said accurate, real-time master policy quote comprises a monthly premium.

10. The mortgage insurance rate quote system for aggregating and presenting accurate, real-time real estate mortgage insurance rate quotes in claim 2, wherein said accurate, real-time master policy quote comprises a single premium, a lender single amount.

11. A non-transitory, computer-readable memory storing instructions that, when executed by a processor, cause the processor to perform a method for aggregating and presenting accurate, real-time real estate mortgage insurance rate quotes, the method comprising:
a) receiving loan information from a mortgage broker system controlled by a mortgage broker through a mortgage insurance rate quote platform;
b) requesting a verification from at least one lender as to a relationship between said at least one lender and said mortgage broker;
c) obtaining said verification from said at least one lender as to said relationship with said mortgage broker;
d) obtaining an accurate, real-time master policy quote from at least one mortgage insurance provider;
e) upon verification of said relationship, presenting said accurate, real-time master policy quote to said mortgage broker system, allowing said mortgage broker to prepare a loan packet.

12. The mortgage insurance rate quote system for aggregating and presenting accurate, real-time real estate mortgage insurance rate quotes in claim 11, wherein said loan information comprises a lender, a loan number, a loan amount, an indicator as to whether a second mortgage is present, a loan to value determination.

13. The mortgage insurance rate quote system for aggregating and presenting accurate, real-time real estate mortgage insurance rate quotes in claim 11, wherein said loan information comprises a street address, a city, a state, as zip code, a housing expense ratio.

14. The mortgage insurance rate quote system for aggregating and presenting accurate, real-time real estate mortgage insurance rate quotes in claim 11, wherein said loan information comprises a debt-to-income calculation, an indicator of non-traditional credit, a number of borrowers, a credit score, a total monthly income.

15. The mortgage insurance rate quote system for aggregating and presenting accurate, real-time real estate mortgage insurance rate quotes in claim 11, wherein said loan information comprises a social security number, an indication of self-employment, a bankruptcy and foreclosure status, an occupancy type.

16. The mortgage insurance rate quote system for aggregating and presenting accurate, real-time real estate mortgage insurance rate quotes in claim 11, wherein said loan information comprises a loan type, an estimated mortgage interest rate, a loan purpose, an amortization schedule, a property type, a number of units, a renewal option, a refundable premium.

17. The mortgage insurance rate quote system for aggregating and presenting accurate, real-time real estate mortgage insurance rate quotes in claim 11, wherein said accurate, real-time master policy quote comprises a mortgage insurance rate quote.

18. The mortgage insurance rate quote system for aggregating and presenting accurate, real-time real estate mortgage insurance rate quotes in claim 11, wherein said accurate, real-time master policy quote comprises a monthly premium.

19. The mortgage insurance rate quote system for aggregating and presenting accurate, real-time real estate mortgage insurance rate quotes in claim 11, wherein said accurate, real-time master policy quote comprises a single premium, a lender single amount.
